(19) United States
(12) Patent Application Publication
(10) Pub. No.: US 2004/0095056 A1
(43) Pub. Date: May 20, 2004

(54) Color cathode ray tube

(76) Inventors: Sang Mun Kim, Kyongsangbuk-do (KR); Koo Hwa Lee, Kyongsangbuk-do (KR); Joong Gon Kho, Kyongsangbuk-do (KR)

Correspondence Address: BIRCH STEWART KOLASCH & BIRCH, PO BOX 747, FALLS CHURCH, VA, 22040-0747, US

(21) Appl. No.: 10/473,389

(22) PCT Filed: Dec. 18, 2001
(86) PCT No.: PCT/KR01/02198

(30) Foreign Application Priority Data
Mar. 31, 2001 (KR) 2001/017086

(51) Int. Cl. H01J 29/10

(52) U.S. Cl. 313/461

(57) ABSTRACT

A color cathode ray tube is disclosed, in which brightness is excellent, uniformity of brightness is improved, and characteristics of contrast are improved. To this end, the color cathode ray tube includes a panel (1) having an inner surface on which an electron bean emitted from an electron gun is irradiated and an outer surface exposed outwardly; black matrixes (10) formed at the inner surface of the panel (1) with a predetermined interval; a fluorescent film (20) composed of red, green, and blue fluorescencers among the black matrixes (10); and a black filter film (30) formed at the outer surface of the panel (1), or between the inner surface of the panel (1) and the fluorescent film (20), or between the inner surface of the panel 1 and the fluorescent film (20) with covering the black matrix (10).

### TECHNICAL FIELD

The present invention relates to a color cathode ray tube, and more particularly, to a color cathode ray tube (CRT) having an excellent contrast and an improved luminance uniformity.

### BACKGROUND ART

Referring to FIG. 1, in general, the color CRT is provided with a panel having a fluorescent film 4 coated on an inside surface thereof, a funnel 2 fitted to rear of the panel 1 having a neck part 3, and an electron gun 6 built in the neck part 3 for emitting electron beams 5 of R, G, B three colors for displaying a fluorescent screen. The color CRT is a display for displaying a picture as the electron beams 5 from the electron gun 6 are controlled by a magnetic field from a deflection yoke 7 fitted to an outside circumference of the neck part, involved in color selection by the shadow mask 8, and hit a required location on the fluorescent film 4 screen, to make the fluorescent material to emit a light.

Referring to FIG. 2, a related art color CRT has a structure in which a black matrix 10 on is provided on the panel 1, and R, G, B fluorescent materials 20 are coated thereon in a sequence. This structure has a problem in that a contrast of the picture becomes poor as the light of particular wavelength emitted from the fluorescent material is affected by an external light reflected at a surface of the CRT.

Accordingly, for solving this problem, firstly, though there have been such attempts that the panel is formed of colored glass, or a colored coating is applied to an outside surface of the panel, for reducing a light transmittivity, and thereby dropping the reflection of the external light, these attempts results in a non-uniformity of a luminance. That is, because it is required that the CRT is at a high vacuum and an outside surface of the panel is flat, leading a thickness of panel glass to become the thicker as it goes from a center of the screen to a periphery of the screen, that causes a great difference of light absorption ratios between the center part and the periphery part, the luminance becomes non-uniform. Particularly, as a trend of making flatter panel becomes the stronger, the difference of light absorption ratios becomes the greater.

In order to overcome this problem, though a light emission area of a fluorescent film in the periphery may be made larger, it has a limitation coming from reduced purity allowance. Or, though a thickness of a face plate of the flat color CRT may be made uniform for solving the problem, the making the face plate to have a uniform thickness is impracticable in reality since a special method of fabricating the color CRT, such as a shape of a shadow mask, an electron beam scanning method, and the like, is required.

Secondly, though color filters identical to respective fluorescent materials may be formed between the inside surface of the panel and the fluorescent film at positions opposite to respective fluorescent materials, for improving the luminance and contrast, this method has a problem of a complicated fabrication process as fabrication of patterns for R, G, B filters are required, even though this method can provide an excellent picture quality.

Thirdly, though a blue filter may be coated on an entire inside surface of the panel, this method has problems in that a light absorption in a red color region is great, to cause great differences of currents provided to the R, G, B cathodes in reproduction of a white color, particularly luminance drop in red color is serious, to cause poor picture reproduction, and focusing characteristics.

Therefore, a high quality color CRT is in need, which is competitive with different color displays, such as LCD (Liquid Crystal Display), EL (Electro Luminescence), PDP (Plasma Display Panel), VFD (Vacuum Fluorescent Display), and the like, that come into appearance to meet recent demands of making the display to be portable, and to save space, particularly, a color CRT is in need, which has excellent luminance and contrast characteristics that are strong points of the color CRT compared to other displays.

### DISCLOSURE OF INVENTION

An object of the present invention is to provide a color CRT which has an excellent luminance, an improved luminance uniformity, and an improved contrast characteristics.

To achieve the object of the present invention, there is provided a color cathode ray tube including a panel having an inside surface electron beams emitted from an electron gun incident thereto, and an outside surface exposed to outside, a black matrix formed at fixed intervals on the inside surface of the panel, a fluorescent film of red, green, and blue fluorescent materials formed between the black matrix, and a black filter film formed between the inside of the panel and the fluorescent film, or a black filter film formed between the inside of the panel and the fluorescent film to cover the black matrix.

In another aspect of the present invention, there is a color cathode ray tube including a panel having an inside surface electron beams emitted from an electron gun incident thereto, and an outside surface exposed to outside, a black matrix formed at fixed intervals on the inside surface of the panel, a fluorescent film of red, green, and blue fluorescent materials formed between the black matrix, and a black filter film formed on an outside of the panel.

The black filter film may be formed on an outside of the panel, and along with this, between the inside surface of the panel and the fluorescent film, additionally. Preferably, the black filter film is formed between the inside of the panel and the fluorescent film to cover the black matrix, additionally.

The panel is a clear panel with a transmittivity higher than 75%, and the black filter film is a transparent black thin film with a 40-90% transmittivity. The black filter film is formed of a black inorganic material selected from a group of materials including graphite, titanium oxide, silicon oxide, tungsten, titanium nitride, and black iron oxide as a main raw material, by processing into a thin film. The black inorganic material has a grain diameter below 0.5 μm.

The black filter film includes an anion group dispersant, and includes a transparent conductive material including stannic oxide, indium oxide added with tin, or zinc oxide added with aluminum.

Preferably, the black filter film has a thickness of 40 nm-1000 nm, the black filter film includes an organic group binder, such as polyvinyl alcohol, or an inorganic group binder, such as organic silane, silica sol, apatite, titania sol, and the like for making attachment of the black filter film to an entire inside of the panel easy. The binder has a content over 10 wt % of the black inorganic material.

### BRIEF DESCRIPTION OF DRAWINGS

FIG. 1 illustrates a related art color CRT, schematically;

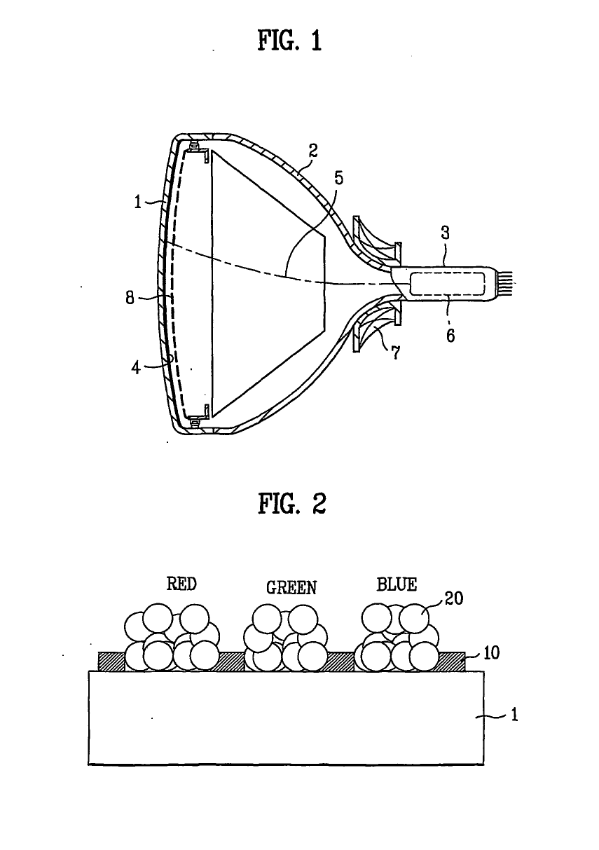

FIG. 2 illustrates a section of a panel part of a related art color CRT;

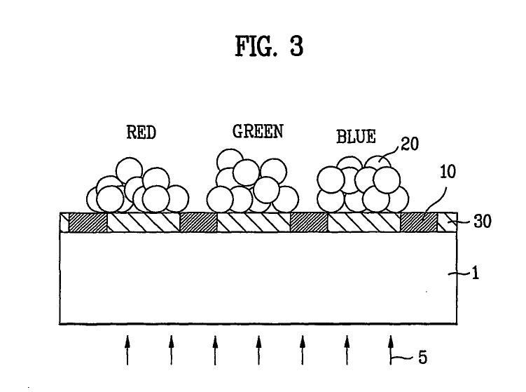

FIGS. 3, 4, and 5 illustrate sections each showing a panel part of a color CRT in accordance with a preferred embodiment of the present invention;

FIG. 6 illustrates a graph showing a thickness of a panel vs. a light transmittivity for different panels; and

FIG. 7 illustrates a graph showing a wavelength vs. a transmittivity for graphite thin films and a panel.

### BEST MODE FOR CARRYING OUT THE INVENTION

Preferred embodiments of the present invention which can achieve the object of the present invention will be explained, with reference to the attached drawings. In explaining the present invention, parts the same with the related art will be given the same names and reference symbols.

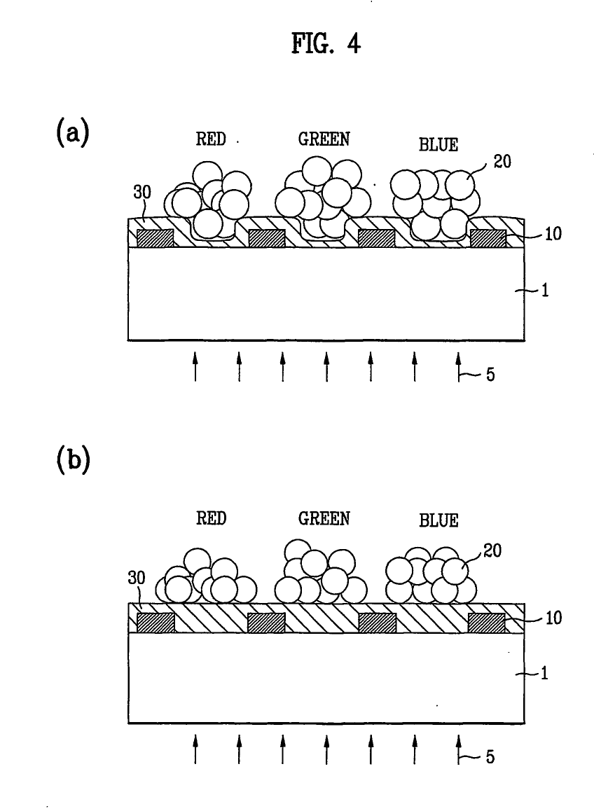

FIG. 3 illustrates one embodiment of the present invention.

Referring to FIG. 3, the present invention provides a CRT including a panel 1 having an inside surface electron beams emitted from an electron gun are directed thereto, a black matrix 10 formed at fixed intervals on the inside surface of the panel, a fluorescent film 20 of red, green, and blue fluorescent materials formed between the black matrix, and a black filter film 30 formed between the inside surface of the panel and the fluorescent film. Preferably, the panel 1 is a clear panel.

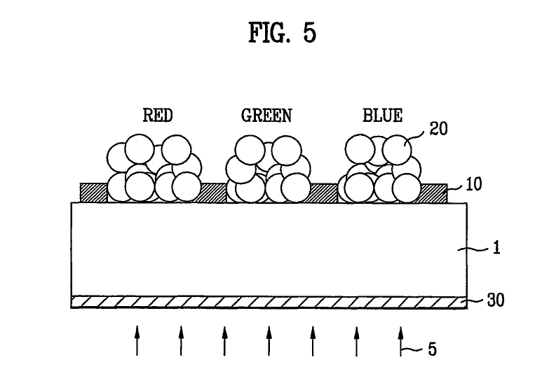

FIG. 6 illustrates a graph showing a thickness of a panel vs. a light transmittivity for different panels, wherein it can be noted that, though the dark tint panel with a transmittivity below 50%, or the tint panel with a transmittivity 50-70% has a light transmission ratio dropped sharply in proportion to variation of a thickness of the panel, the clear panel with a tannsmittivity higher than 75% has a light transmission ratio varied little in proportion to variation of a thickness of the panel. Therefore, the clear panel shows below 5% difference of transmission ratios between a center part and a periphery of the panel, to provide a small luminance difference between the center part and the periphery of the panel if the luminance is reviewed with the following equation.

B=(Tg·Econv)[T(Is·Vs/H·W)][1−(tb/t)],

Where, Tg denotes a light transmittivity of a face plate of a panel,

Econv denotes a conversion efficiency of a fluorescent material screen,

T denotes a ratio of an electron beam colliding the fluorescent material,

Is denotes a beam current,

Vs denotes a screen voltage,

H·W denotes a screen area,

tb/t denotes a time period no electron beam scans, and overscan, and

B denotes a luminance of a color CRT.

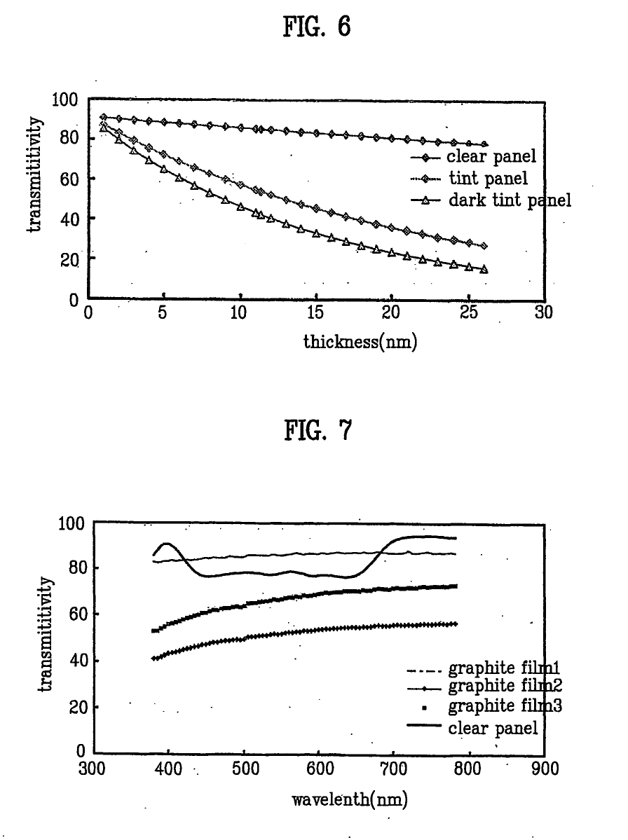

FIG. 7 illustrates a graph showing a wavelength vs. a transmittivity for graphite thin films and a panel, wherein it can be noted that a graphite film drops a light transmission ratio of the panel throughout entire visible light range, to serve as an optical filter for improving contrast. That is, the graphite film improves a transmission ratio difference throughout the screen, to improve a luminance uniformity, and satisfies the luminance uniformity and the improvement of contrast on the same time by light absorption of a transparent black thin film that improves the contrast.

It is preferable that the black filter film has a transmission ratio in a range of 40% -90%. When the transmission ratio is below 40%, the light absorption ratio of the black filter film increases, to make formation of a screen difficult, and when the transmission ratio of the black filter film is higher than 90%, a function of the black filter film as an optical filter becomes poor. More preferably, the black filter film has a transmission ratio in a range of 60%-85%.

Preferably, the black filter film is a transparent black thin film formed of a black inorganic material selected from a group of materials including graphite, titanium oxide, silicon oxide, tungsten, titanium nitride, and black iron oxide, and by processing into a thin film. The black inorganic material preferably has a grain diameter below 0.5 μm.

In order to secure above transmission ratio, it is preferable that the black filter film has a thickness of 40nm-1000 nm. When the thickness is below 40 nm, the black filter film has a poor function as an optical filter, and when the thickness is over 1000 nm, formation of the screen by exposure is difficult due to a high light absorption ratio when the fluorescent material is coated for forming the screen. It is more preferable that the black filter film has a thickness of 300 nm-1000 nm.

A concentration of powder in a dispersed liquid of the black inorganic powder is preferably 0.05 wt %-10 wt % for forming the transparent black thin film. When the concentration is below 0.05 wt %, a film thickness is too thin to work as a filter satisfactorily, and when the concentration is over 10 wt %, the film thickness is too thick to form the screen by exposure due to too high a light absorption ratio when it is intended to form the screen by coating the fluorescent material. More preferably, the concentration is 0.1 wt %-1.0 wt %.

In the present invention, a binder may be used for making attachment of the black filter film to an entire inside of the panel easy. As the binder, an organic group binder, such as polyvinyl alcohol, or an inorganic group binder, such as organic silane, silica sol, apatite, titania sol, and the like. It is preferable that a content of the binder is 10 wt % of a content of the black inorganic material. When the content is below 10 wt %, the transparent thin film attached to the panel may be peeled off due to a weak adhesive force after the transparent black thin film is dried.

In the present invention, in order to improve dispersability of the black inorganic powder, to improve a uniformity of a film when the black filter film is coated, a dispersant may be used. As the dispersant, anion dispersant is preferable, with a content of 0.05-5.0 wt % of a content of the black inorganic material.

In the present invention, in order to improve a conductivity of the black filter film, a trasparent conductive material may be used. As the transparent conductive film, preferably, stannic oxide, indium oxide added with tin, or zinc oxide added with aluminum, with a grain diameter the same with, or smaller than a grain diameter of the black inorganic material. If the grain diameter of the transparent conductive material is greater than the grain diameter of the black inorganic material, the transparent conductive material may affect a light transmittivity. It is preferable that a content of the transparent conductive material is 20wt %-200 wt % of a content of the black powder.

However, it is required that the conductivity of the black filter film is below 80000Ω. If the conductivity is higher than 8000Ω, it is difficult for the black filter film to serve as a transparent electrode, and it is difficult to remove electrons accumulated on a surface of the fluorescent material, to cause a problem of poor luminance.

FIGS. 4A and 4B illustrate sections each showing a panel part of a color CRT in accordance with a preferred embodiment of the present invention.

The present invention provides a CRT including a panel 1 having an inside surface electron beams 5 emitted from an electron gun being incident thereto and an outside surface exposed to an outside, a black matrix 10 formed on the inside surface of the panel at fixed intervals, a fluorescent film 20 of red, green, and blue fluorescent materials between the black matrix, and a filter film 30 between the inside surface of the panel and the fluorescent film to cover the black matrix.

The embodiment is identical to the embodiment of FIG. 3 in view of a material of the panel, a transmittivity of the black filter film, materials, thicknesses, binder, dispersant, conductive material, and the like, except that the filter film 30 covers the black matrix.

If the black filter film has a thickness thinner than the thickness of the black matrix, the panel part of the CRT includes a form as shown in FIG. 4A, and if the black filter film has a thickness thicker than the thickness of the black matrix, the panel part of the CRT includes a form as shown in FIG. 4B. A form as shown in FIG. 4B is more preferable.

FIG. 5 illustrates a section showing a panel part of a color CRT in accordance with a preferred embodiment of the present invention.

The present invention provides a CRT including a panel 1 having an inside surface electron beams 5 emitted from an electron gun being incident thereto and an outside surface exposed to an outside, a black matrix 10 formed on the inside surface of the panel at fixed intervals, a fluorescent film 20 of red, green, and blue fluorescent materials between the black matrix, and a black filter film 30 formed on an outside surface of the panel.

The embodiment is identical to the embodiment of FIG. 3 in view of a material of the panel, a transmittivity of the black filter film, materials, thicknesses, binder, dispersant, conductive material, and the like, except that the black filter film 30 is formed on the outside surface of the panel.

Though not shown in the drawings, the black filter film may be coated on the inside and the outside of the panel. In this instance, the black filter film may be formed on the inside surface like FIG. 3 covering the black matrix, or like FIG. 4, without covering the black matrix.

Preferred embodiments and comparative examples of the present invention will be explained.

### EMBODIMENT 1

A color CRT is fabricated by a general color CRT fabrication process after forming a black matrix on a panel with a 80% transmittivity, forming a graphite thin film of an 80% transruttivity on an entire inside surface of the panel, of a graphite liquid with a graphite powder concentration of 0.1 wt % added with 20 wt % silica sol with respect to the graphite powder as a binder, and coating red, green, and blue slurry, to form a screen.

### EMBODIMENT 2

A color CRT is fabricated by a general color CRT fabrication process after forming a black matrix of a graphite liquid on a panel with a transmittivity the same with the embodiment 1, forming a graphite thin film of a 70% transmittivity on an entire inside surface of the panel, of a graphite liquid with a graphite powder concentration of 0.3 wt % added with 40 wt % silica sol with respect to the graphite powder as a binder, and coating red, green, and blue slurry, to form a screen.

### COMPARATIVE EXAMPLE 1

A color CRT is fabricated by a general color CRT fabrication process after forming a black matrix on a panel with a transmittivity the same with the embodiment 1, without forming no a graphite thin film, and coating red, green, and blue slurry, to form a screen.

### COMPARATIVE EXAMPLE 2

A color CRT is fabricated by a general color CRT fabrication process after forming a black matrix on a panel with a tint transmittivity, without forming no a graphite thin film, and coating red, green, and blue slurry, to form a screen.

Table 1 shows evaluation of transmittivities of color CRTs fabricated by the embodiments of the present invention and the comparative examples.

TABLE 1

| | E1* | E2* | C1* | C2* |
|---|---|---|---|---|
| Transmittivity at a center of panel (%) | 80 | 80 | 80 | 60 |
| Transmittivity at a periphery of panel (%) | 74 | 74 | 74 | 39 |
| Transmittivity of a thin film (%) | 80 | 70 | — | — |
| Transmittivity at a center of panel with a thin | 64 | 56 | 80 | 60 |
| film (%) | | | | |
| Transmittivity at a periphery of panel with a | 59 | 52 | 74 | 39 |
| thin film (%) | | | | |
| Luminance at a center (FL) | 40 | 39 | 50 | 40 |
| Luminance at a periphery of panel (FL) | 37 | 37 | 46 | 24 |
| Contrast (%) | 140 | 150 | 100 | 145 |
| Uniformity of luminance (%) | 92.5 | 91.4 | 92 | 60 |

E1: Embodiment 1,
E2: Embodiment 2,
C1: Comparative Example 1, and
C2: Comparative Example 2.

Referring to table 1, it can be noted that a transmittivity of panel with a thin film is a product of a transmittivity of the panel and a transmittivity of the thin film, there is a small difference of luminance between the center and the periphery, and there is an improvement of contrast.

When the embodiments are compared with the comparative examples in which no graphite thin films are designed, it can be noted that, though the comparative example 1 has a uniformity of luminance similar to the embodiments, the contrast is very poor, and, though the comparative example 2 has a contrast similar to the embodiments, the uniformity of luminance is poor.

### INDUSTRIAL APPLICABILITY

The foregoing CRT of the present invention improves a difference of transmittivities of screen, to improve uniformity of luminance, and improves a contrast by absorbing lights in a visible range, that drops a transmittivity, thereby providing a more improved picture to watcher of CRTs.

What is claimed is:

1. A color cathode ray tube comprising:
a panel having an inside surface electron beams emitted from an electron gun incident thereto, and an outside surface exposed to outside;
a black matrix formed at fixed intervals on the inside surface of the panel;
a fluorescent film of red, green, and blue fluorescent materials formed between the black matrix; and
a black filter film formed between the inside of the panel and the fluorescent film.

2. A color cathode ray tube comprising:
a panel having an inside surface electron beams emitted from an electron gun incident thereto, and an outside surface exposed to outside;
a black matrix formed at fixed intervals on the inside surface of the panel;
a fluorescent film of red, green, and blue fluorescent materials formed between the black matrix; and
a black filter film formed between the inside of the panel and the fluorescent film to cover the black matrix.

3. A color cathode ray tube comprising:
a panel having an inside surface electron beams emitted from an electron gun incident thereto, and an outside surface exposed to outside;
a black matrix formed at fixed intervals on the inside surface of the panel;
a fluorescent film of red, green, and blue fluorescent materials formed between the black matrix; and
a black filter film formed on an outside of the panel.

4. A color cathode ray tube as claimed in claim 3, further comprising a black filter film between the inside surface of the panel and the fluorescent film, additionally.

5. A color cathode ray tube as claimed in claim 3, further comprising a black filter film between the inside of the panel and the fluorescent film to cover the black matrix, additionally.

6. A color cathode ray tube as claimed in one of claims 1-5, wherein the panel is a clear panel with a transmittivity higher than 75%.

7. A color cathode ray tube as claimed in one of claims 1-5, wherein the black filter film is a transparent black thin film with a 40-90% transmittivity.

8. A color cathode ray tube as claimed in one of claims 1-5, wherein the black filter film is formed of a black inorganic material selected from a group of materials including graphite, titanium oxide, silicon oxide, tungsten, titanium nitride, and black iron oxide as a main raw material, by processing into a thin film.

9. A color cathode ray tube as claimed in claim 8, wherein the black inorganic material has a grain diameter below 0.5 μm.

10. A color cathode ray tube as claimed in one of claims 1-5, wherein the black filter film has a thickness of 40 nm-1000 nm.

11. A color cathode ray tube as claimed in claim 8, wherein the black filter film includes an organic group binder, such as polyvinyl alcohol, or an inorganic group binder, such as organic silane, silica sol, apatite, titania sol, and the like for making attachment of the black filter film to an entire inside of the panel easy.

12. A color cathode ray tube as claimed in claim 11, wherein the binder has a content over 10 wt % of the black inorganic material.

13. A color cathode ray tube as claimed in one of claims 1-5, wherein the black filter film includes an anion group dispersant.

14. A color cathode ray tube as claimed in one of claims 1-5, wherein the black filter film includes a transparent conductive material including stannic oxide, indium oxide added with tin, or zinc oxide added with aluminum.
